(19) United States
(12) Patent Application Publication
(10) Pub. No.: US 2018/0329909 A1
(43) Pub. Date: Nov. 15, 2018

(54) INSTRUCTIONAL CONTENT QUERY RESPONSE

(71) Applicant: LinkedIn Corporation, Sunnyvale, CA (US)

(72) Inventors: Coleman Patrick King, III, Brooklyn, NY (US); Tony Yin, Millbrae, CA (US)

(21) Appl. No.: 15/595,462

(22) Filed: May 15, 2017

(51) Int. Cl. G06F 17/30; G06Q 50/00

(52) U.S. Cl. CPC G06F 17/30035; G06F 17/30601; G06Q 50/01; G06F 17/30713; G06F 17/3071

(57) ABSTRACT

Systems, devices, media, and methods are presented for identifying attributes among sets of user profiles to generate graphical user interfaces displaying data sets based on queries and the identified attributes. The systems and methods identify a set of common attributes among a subset of users and determine that a subset of user profiles for the subset of users contain a common characteristic. The systems and methods generate a cluster representation of the set of common attributes and determine one or more common attributes introduced into the subset of user profiles within a specified period of time. In response to determining the one or more common attributes, the systems and methods cause presentation of the one or more common attributes within a graphical user interface and cause presentation of one or more data sets associated with the one or more common attributes.

### TECHNICAL FIELD

Embodiments of the present disclosure relate generally to the technical field of query-based data set serving. Specifically, the present disclosure describes systems and methods to identify attributes among user profiles and generate graphical user interfaces displaying data sets based on queries and the identified attributes.

### BACKGROUND

Network-based publication systems enable users to publish documents, pages, and other content. Users may access and view published content on the network-based publication system via a network linking the network-based publication system to a client device. A social networking system allows members to declare information about themselves, such as their professional qualifications or skills. In addition to information the members declare about themselves, a social networking system may log information pertaining to behaviors of members with respect to the social networking system and social networks of members of the social networking system.

### BRIEF DESCRIPTION OF THE SEVERAL VIEWS OF THE DRAWINGS

Some embodiments are illustrated by way of example and not limitation in the accompanying drawings, in which:

FIG. 1 is a block diagram of the functional components that comprise a computer- or network-based social networking system, including a content server system, consistent with some embodiments described herein;

FIG. 2 is a block diagram depicting components of the content server system of FIG. 1, in accordance with an example embodiment;

FIG. 3 is a flow diagram illustrating a method of identifying attributes among sets of user profiles to identify data sets configured to support incorporation of a selected attribute into a user profile, according to some embodiments of the present disclosure;

FIG. 4 is a user interface diagram depicting an organized set of attributes, according to some example embodiments;

FIG. 5 is a flow diagram illustrating a method of identifying attributes among sets of user profiles to identify data sets configured to support incorporation of a selected attribute into a user profile, according to some embodiments of the present disclosure;

FIG. 6 is a flow diagram illustrating a method of identifying attributes among sets of user profiles to identify data sets configured to support incorporation of a selected attribute into a user profile, according to some embodiments of the present disclosure;

FIG. 7 is a flow diagram illustrating a method of identifying attributes among sets of user profiles to identify data sets configured to support incorporation of a selected attribute into a user profile, according to some embodiments of the present disclosure; and

FIG. 8 is a block diagram of a machine in the form of a computing device within which a set of instructions may be executed for causing the machine to perform any one or more of the methodologies discussed herein.

### DETAILED DESCRIPTION

Example methods and systems are shown for analyzing a social network to predict queries, rankings, trends, and other actions on data sets within a networked system. In some embodiments, the methods and systems described herein enable analysis of a social network to predict member actions within the social networking system. In some example embodiments, members within a group on a social network log one or more changes to a data set (e.g., member profiles) in a social networking system. The one or more changes may correspond to a specified element or element type, such as a skill, an educational credential, a certification, or other attribute of a member profile. A content server system may identify attributes among sets of member profiles to identify data sets (e.g., instructional content) configured to support incorporation of a selected attribute into a member profile.

Identifying trends and knowing what content or skills to learn may present difficulties to members of social networks. In some embodiments, the content server system identifies characteristics of a group as an industry, a function, an occupation, or other suitable characteristic. Data relating to skills, industries, functions, occupations, and professions may be used to show important, growing, and trending skills. The content server system may identify, from profile data within a group of members, trending profile attributes, such as skills or educational credentials, and recommend content from a learning library corresponding to those skills or educational credentials. The content server system may calculate top, trending, or unique skills or attributes within the group and all applicable member profiles. From the skills or attributes, the content server system identifies the instructional content that, once consumed by a member, justify the addition of a skill or attribute by a member outside of the group of members.

Social networking systems provide various profile options and services. In some instances, a social network may connect members (e.g., individuals associated with the social network) and organizations alike. Social networking services have also become a popular method of performing organizational research and job searching. Job listings representing openings (e.g., employment and volunteer positions) within an organization may be posted and administered by the organization or third parties (e.g., recruiters, employment agencies, etc.).

A social networking system may have a vast array of information pertaining to members of the social networking system, companies maintaining a social networking presence on the social networking system, and interactions between members, companies, and content provided by both the members and companies to the social networking system. As will be discussed in more detail below, information pertaining to members of the social networking system can include data items pertaining to education, work experience, skills, reputation, certifications, and other qualifications of each of the members of the social networking system at particular points during the careers of these members, or interaction data indicating a history of interactions with content on the social networking system. This information pertaining to members of the social networking system may be member-generated to enable individualization of social networking profiles as well as to enable dynamic and organic expansion and discovery of fields of experience, education, skills, and other information relating to personal and professional experiences of members of the social networking system.

Other aspects of the present inventive subject matter will be readily apparent from the description of the figures that follow.

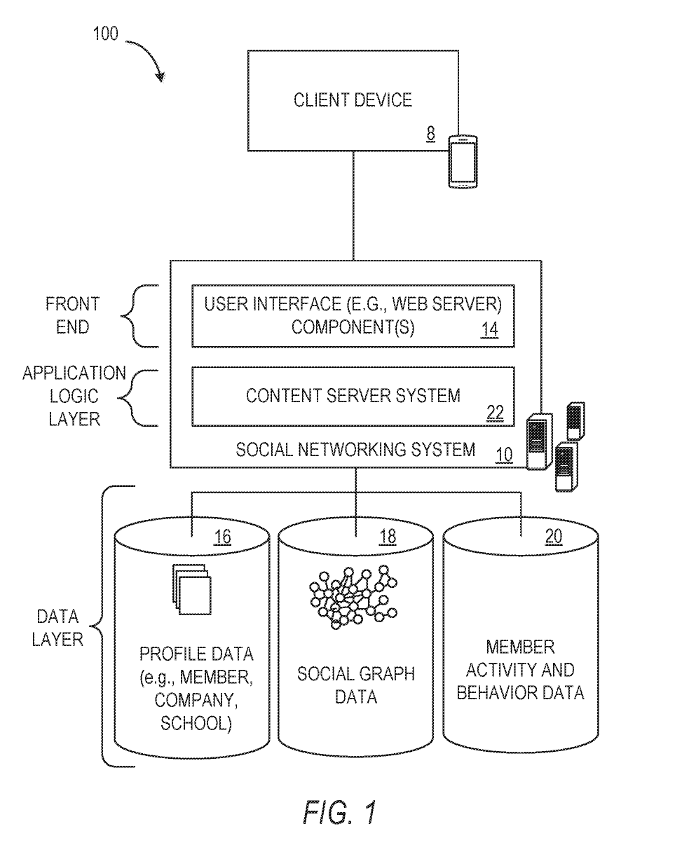

FIG. 1 is a block diagram 100 of the functional components that comprise a computer or network-based social networking system 10, consistent with some embodiments of the inventive concepts of the present disclosure. In some embodiments, the social networking system 10 acts as a network-based publication system. In these instances, as shown in FIG. 1, the social networking system 10 is generally based on a three-tiered architecture, comprising a front end layer, application logic layer, and data layer. As is understood by skilled artisans in the relevant computer and Internet-related arts, each component or engine shown in FIG. 1 represents a set of executable software instructions (e.g., an instruction set executable by a processor) and the corresponding hardware (e.g., memory and processor) for executing the instructions. To avoid obscuring the inventive subject matter, various functional components and engines that are not germane to conveying an understanding of the inventive subject matter have been omitted from FIG. 1. However, a skilled artisan will readily recognize that various additional functional components and engines may be used with a social networking system 10, such as that illustrated in FIG. 1, to facilitate additional functionality that is not specifically described herein. Furthermore, the various functional components and engines depicted in FIG. 1 may reside on a single server computer, or may be distributed across several server computers in various arrangements. Moreover, although the social networking system 10 is depicted in FIG. 1 as having a three-tiered architecture, the inventive subject matter is by no means limited to such architecture.

As shown in FIG. 1, the front end comprises a user interface component 14 (e.g., a web server), which receives requests from various client devices 8, and communicates appropriate responses to the requesting client devices 8. For example, the user interface component 14 may receive requests in the form of Hypertext Transfer Protocol (HTTP) requests or other web-based application programming interface (API) requests. The client devices 8 may be executing conventional web browser applications or applications that have been developed for a specific platform to include any of a wide variety of mobile devices and operating systems.

As shown in FIG. 1, the data layer includes several databases, including one or more databases 16 for storing data relating to various entities represented in a social graph. In some embodiments, these entities include members, companies, and/or educational institutions, among possible others. Consistent with some embodiments, when a person initially registers to become a member of the social networking service, and at various times subsequent to initially registering, the person will be prompted to provide some personal information, such as his or her name, age (e.g., birth date), gender, interests, contact information, home town, address, spouse's and/or family members' names, educational background (e.g., schools, majors, etc.), current job title, job description, industry, employment history, skills, professional organizations, and so on. This information is stored as part of a member's member profile, for example, in the database 16. In some embodiments, a member's profile data will include not only the explicitly provided data, but also any number of derived or computed member profile attributes and/or characteristics.

Once registered, a member may invite other members, or be invited by other members, to connect via the social networking service. A “connection” may mean a bilateral agreement by the members, such that both members acknowledge the establishment of the connection. Similarly, in some embodiments, a member may elect to “follow” another member. In contrast to establishing a “connection,” the concept of “following” another member typically is a unilateral operation and, at least in some embodiments, does not include acknowledgement or approval by the member who is being followed. When one member follows another, the member who is following may receive automatic notifications about various activities undertaken by the member being followed. In addition to following another member, a member may elect to follow a company, a topic, a conversation, or some other entity. In general, the associations and relationships that a member has with other members and other entities (e.g., companies, schools, etc.) become part of the social graph data maintained in a database 18. In some embodiments, a social graph data structure may be implemented with a graph database (e.g., the database 18), which is a particular type of database that uses graph structures with nodes, edges, and properties to represent and store data. In this case, the social graph data stored in the database 18 reflects the various entities that are part of the social graph, as well as how those entities are related with one another.

In various alternative embodiments, any number of other entities might be included in the social graph and, as such, various other databases may be used to store data corresponding with the other entities. For example, although not shown in FIG. 1, consistent with some embodiments, the social networking system 10 may include additional databases for storing information relating to a wide variety of entities, such as information concerning various online or offline groups, job listings or postings, photographs, audio or video files, and so forth.

In some embodiments, the social networking service may include one or more activity and/or event-tracking components, which generally detect various member-related activities and/or events, and then store information relating to those activities/events in a database 20. For example, the tracking components may identify when a member makes a change to some attribute of his or her member profile or adds a new attribute. Additionally, a tracking component may detect the interactions that a member has with different types of content. Such information may be used, for example, by one or more recommendation engines to tailor the content presented to a particular member, and generally to tailor the member experience for a particular member.

The application logic layer includes various application server components, which, in conjunction with the user interface component 14, generate various user interfaces (e.g., web pages) with data retrieved from various data sources in the data layer. In some embodiments, individual application server components are used to implement the functionality associated with various applications, services, and features of the social networking service. For instance, a messaging application, such as an email application, an instant messaging application, a social networking application native to a mobile device, a social networking application installed on a mobile device, or some hybrid or variation of these, may be implemented with one or more application server components implemented as a combination of hardware and software elements. Of course, other applications or services may be separately embodied in their own application server components.

As shown in FIG. 1, a content server system 22 is an example application server component of the social networking system 10. The content server system 22 performs operations to identify attribute among sets of user profiles to identify data sets (e.g., instructional content) configured to support incorporation of a selected attribute into a user profile. In some embodiments, the content server system 22 operates in conjunction with the user interface components 14 to receive sets of publication data, sets of member data, and member input to generate tailored user interface presentations including data sets or content configured to instruct, present, or otherwise justify addition of a specified attribute (e.g., a skill) to a member profile. For example, the content server system 22 may render graphical representations of a set of attributes (e.g., a set of skills) common to a set of members according to one or more of a relevance to the set of members; a uniqueness to the set of members; a trend; combinations of one or more of the relevance, uniqueness, and trends; or any other suitable basis. In embodiments where the graphical representation of the set of attributes are rendered based on or in accordance with a trend, the content server system 22 may identify a trend of incorporating a common attribute into profiles of members determined to have a common characteristic. The content server system 22 may then order the graphical representation of the set of attributes based on a time, frequency, or other basis for the trend.

The social networking system 10 may provide a broad range of applications and services that allow members the opportunity to share and receive information, often customized to the interests of the member. For example, in some embodiments, the social networking system 10 may include a photo sharing application that allows members to upload and share photos with other members, or a slide sharing application, which allows members to upload slide decks for sharing among other members. In some embodiments, members of the social networking system 10 may be able to self-organize into groups, or interest groups, organized around a subject or topic of interest. Accordingly, the data for a group may be stored in a database (not shown). When a member joins a group, his or her membership in the group will be reflected in the social graph data stored in the database 18. In some embodiments, members may subscribe to or join groups affiliated with one or more companies. For instance, in some embodiments, members of the social networking system 10 may indicate an affiliation with a company at which they are employed, such that news and events pertaining to the company are automatically communicated to the members. In some embodiments, members may be allowed to subscribe to receive information concerning companies other than the company with which they are employed. Here again, membership in a group, a subscription or following relationship with a company or group, and an employment relationship with a company are all examples of the different types of relationships that may exist between different entities, as defined by the social graph and modeled with the social graph data of the database 18.

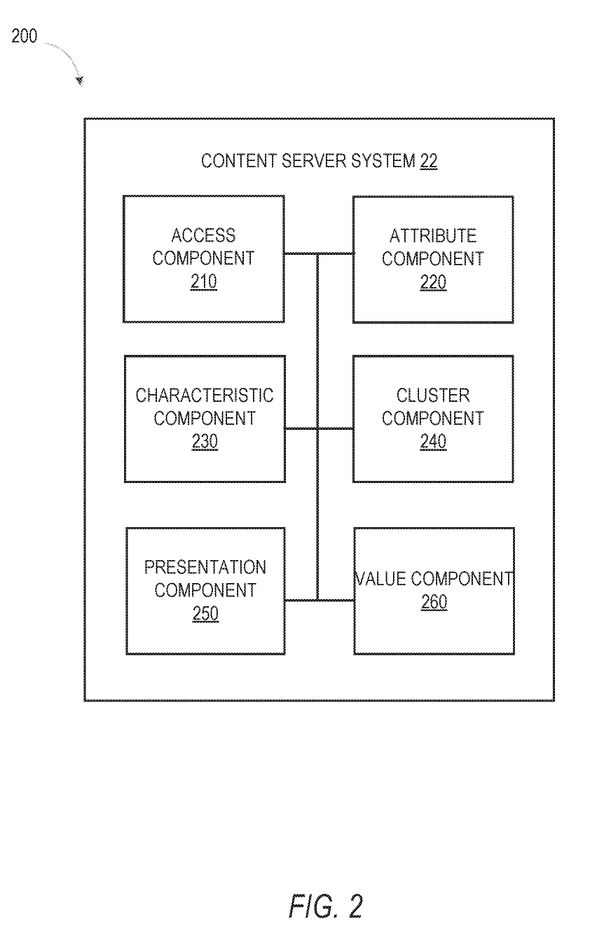

FIG. 2 is a block diagram 200 depicting some example components of the content server system 22 of FIG. 1. The content server system 22 is shown including an access component 210, an attribute component 220, a characteristic component 230, a cluster component 240, a presentation component 250, and a value component 260, all configured to communicate with each other (e.g., via a bus, shared memory, a switch, or a network). Any one or more of the components described herein may be implemented using hardware (e.g., one or more processors specifically configured to perform the operations described herein) or a combination of hardware and software, forming a hardware-software implemented component. For example, any component described herein may configure a processor (e.g., among one or more processors of a machine) as a special-purpose machine, during the pendency of a set of operations, to perform the operations described herein for that component. A pendency of operations may be understood as a state or time during which the set of operations are being performed or the time during which and just prior to the set of operations being performed. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices.

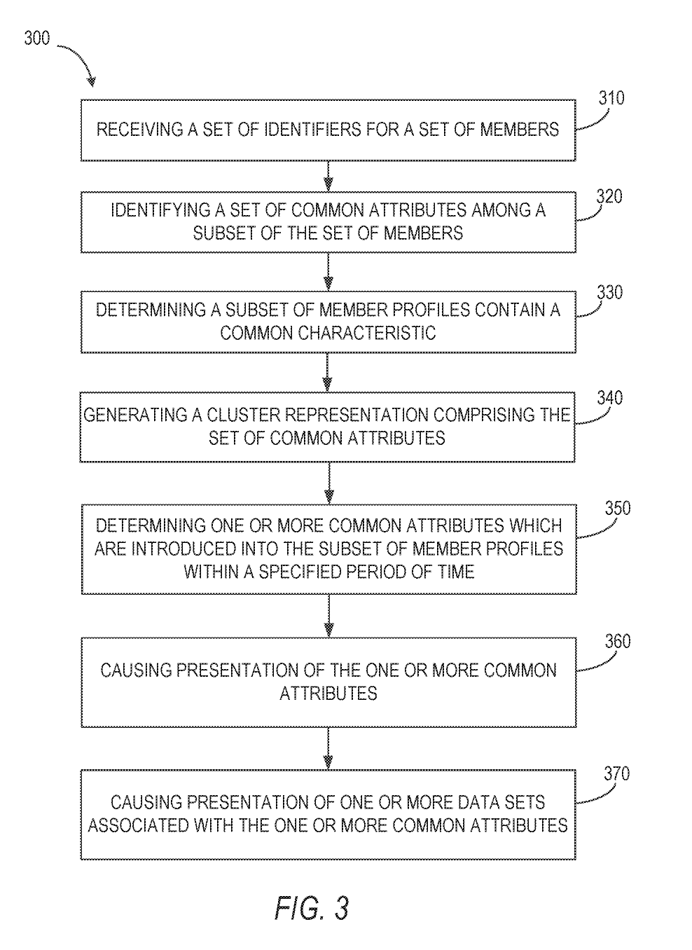

FIG. 3 is a flow diagram illustrating an example method 300 of identifying attributes among sets of user profiles to identify data sets (e.g., instructional content) configured to support incorporation of a selected attribute into a user profile, consistent with various embodiments described herein. For example, the method 300 may comprise identifying a group of members with a common characteristic, identifying a trend in adding attributes to member profiles within the group, and presenting data sets (e.g., instructional content) to members which may enable the members to justify adding the attribute to their member profiles. The method 300 may be performed, at least in part, by, for example, the content server system 22 illustrated in FIG. 2 (or an apparatus having similar components or operative programming, such as one or more client machines or application servers).

In operation 310, the access component 210 receives a set of identifiers for a set of users. The set of identifiers are associated with a set of user profiles comprising attributes of the set of users. In some embodiments, the set of user profiles are profiles of users or members registered or otherwise associated with a social network of the social networking system 10. The access component 210 may receive the set of identifiers as a scheduled task of the content server system 22. In such embodiments, the access component 210 receives the set of identifiers and accesses member profiles associated with the set of identifiers.

In some instances, the access component 210 receives one or more identifiers of the set of identifiers as included in a query. In such instances, the access component 210 receives the one or more identifiers in a query structured for access or searching of member profiles. The access component 210 may also access the identifiers as a result of a received query. In instances where the access component 210 receives a query, the query may be structured or unstructured. A structured query may be standardized as a drop-down menu, a term-completing query (e.g., suggesting search terms based on words or partial words entered into a text field), or any other suitable query technique structured for entering a keyword from a predetermined set of keywords. An unstructured query may be a free-form query, such as a text entry field, configured to receive terms or combinations of terms chosen by a user. The query (e.g., a specified attribute, skill, characteristic, or job) may cause the access component 210 to parse a database or data structure to identify and retrieve or receive the set of identifiers or one or more identifiers for the set of users.

In operation 320, the attribute component 220 identifies a set of common attributes among a subset of the set of users. The set of common attributes are associated with a subset of user profiles of the subset of users. In some embodiments, the attribute component 220 identifies the set of common attributes using one or more operations. In such embodiments, the attribute component 220 parses attributes comprising the set of user profiles. The attribute component 220 may parse the attributes using text recognition, keyword spotting, lexical analysis, pattern recognition, or any other suitable text analytics or data mining technique. In some instances, the attribute component 220 parses the attributes by identifying attributes in predetermined fields of a structured profile. In such embodiments, specified attributes may be stored in predetermined fields of a data structure representing the member profile.

In response to parsing the attributes associated with the member profiles of the subset of users, the attribute component 220 matches a plurality of attributes among the set of user profiles. The plurality of attributes matched among the set of user profiles represent attributes in common among the set of members. In response to matching the plurality of attributes, the attribute component 220 identifies a set of mismatching attributes among the set of user profiles. The mismatching attributes represent attributes shared by a subset of the set of member profiles. Such mismatching attributes may be common attributes or a portion of common attributes of the subset of members, selected from the set of members. The subset of members may represent a self-contained group within the set of members.

In operation 330, the characteristic component 230 determines that the subset of user profiles contain a common characteristic. The common characteristic is associated with the subset of users. In some embodiments, the common characteristic defines a group of users including or included within the subset of users. The common characteristic may define a group as a profession, a set of employees, a class of jobs, a field, a locale (e.g., a location, a geographic area, or a region), or any other suitable aspect defining a group. For example, the common characteristic may be a group of users having a characteristic job, such as software developer, programmer, human resources professionals, or any other suitable job.

In some embodiments, the characteristic component 230 determines the subset of user profiles as containing the common characteristic by identifying one or more attributes of the set of mismatching attributes within the subset of user profiles. The one or more attributes are common to the subset of user profiles which are also associated with one or more characteristic. The one or more characteristic may be determined to be the common characteristic. Upon selecting or determining the common characteristic, the attribute component 220 selects the one or more attributes as the one or more common attributes for the subset of user profiles.

In operation 340, the cluster component 240 generates a cluster representation. In some embodiments, the cluster representation comprises a set of common attributes for user profiles of the subset of users in the group of users. The cluster representation may include a plurality of graphical elements. Each graphical element of the plurality of graphical elements may represent a common attribute of the set of common attributes. In some instances, graphical elements representing differing attributes reflect a different character, nature, or status held by the attribute. In some embodiments, the cluster representation of the set of common attributes reflects or represents interrelations among the set of common attributes. The cluster representation may also reflect a context of the common attributes. The context of the common attributes may indicate a time, time period, frequency, rate, geographic, or other contextual characteristic at which or within which each attribute was added to a corresponding member profile.

In operation 350, the attribute component 220 determines one or more common attributes of the set of common attributes which are introduced into the subset of user profiles within a specified period of time. The attribute component 220 may identify the specified period of time. The period of time may be predetermined by one or more of the social networking system 10 and the content server system 22.

In some embodiments, the period of time is determined dynamically. In such embodiments, the attribute component 220 determines a current time and a time for entry of a first common attribute. The attribute component 220 may then determine an overall period of time for the set of common attributes. The attribute component 220 may then select the specified period of time from the overall period of time. The attribute component 220 may select the specified period of time as a portion (e.g., a fraction, an equal portion, or an unequal portion) of the overall period of time ending with the current time, a subset of time terminating at the current time and including a rate of attribute entry above an entry threshold, or any other suitable selection metric.

Although described as a specified period of time, in some embodiments, the attribute component 220 determines the one or more common attributes as being introduced in a specified period of time having a specified rate of entry. The specified rate of entry may be a rate at which members of the subset of members introduced the one or more common attributes to member profiles. The rate, in these instances, may reflect a trend in adding the one or more common attributes to profiles within the social network.

After identifying the specified period of time, the attribute component 220 identifies a time associated with entry of each common attribute of the set of common attributes. The attribute component 220 identifies the one or more common attributes as attributes associated with a time falling within the specified period of time. Upon identifying the one or more common attributes, the attribute component 220 may pass an indication of the one or more common attributes to one or more other components of the content server system 22 for presentation within a graphical user interface.

In operation 360, the presentation component 250 causes presentation of the one or more common attributes in response to determining that the one or more common attributes are being introduced in the specified period of time. In some embodiments, the one or more common attributes are presented within a graphical user interface presented at a client device associated with a first user. The one or more common attributes may be identified in a presentation comprising the cluster representation of the set of common attributes. The first user may be associated with a first user profile containing the common characteristic.

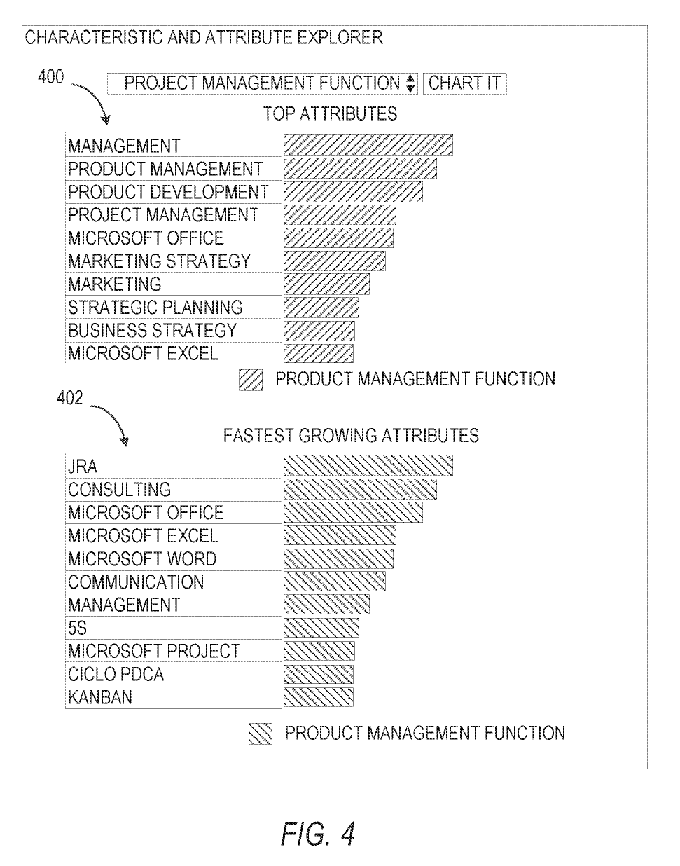

As shown in FIG. 4, in some embodiments, the one or more common attributes are presented in a manner similar to a bar graph. Each common attribute of the one or more common attributes may comprise a bar within the graphical user interface. In FIG. 4, a portion of the set of common attributes are presented as a first bar graph 400 (e.g., “Top Skills”). In some instances, the first bar graph 400 may represent the common characteristic defining the group of users within the subset of users. As shown, each bar is associated with an attribute or characteristic. FIG. 4 also shows the one or more common attributes depicted as a second bar graph 402 (e.g., “Fastest Growing Skills”). The second bar graph 402 represents each common attribute of the one or more common attribute as an individual bar. In some embodiments, as shown in FIG. 4, the one or more common attributes are nested attributes relating to a specified attribute of the set of common attributes or a specified common characteristic defining the group of users.

In operation 370, the presentation component 250 causes presentation of one or more data sets associated with the one or more common attributes in response to causing presentation of the one or more common attributes. In some embodiments, the presentation component 250 presents the one or more data sets within the graphical user interface presented at the client device associated with the first user. In some instances, the one or more data sets are instructional data, courses, training materials, certification classes, or other suitable instructional information associated with at least one of the one or more common attributes. Each data set of the one or more data sets may correspond to a single common attribute, a plurality of related common attributes, or a portion of common attributes. Interaction with a data set may instruct or otherwise confer information sufficient to justify addition of a common attribute to a user profile. For example, a data set may be a self-contained instructional class or course associated with a certification (e.g., a common attribute). Completion of the instructional class and scoring above a threshold test score may earn the certification for the user, conferred by a competent certifying authority or organization. Upon completion of the class and test (e.g., interacting with the data set to earn the certificate), the user may add the corresponding common attribute to the member profile associated with the user.

In some embodiments, causing presentation of the one or more data sets comprises one or more operations or sub-operations. In such embodiments, the attribute component 220 identifies a plurality of data sets. The data sets may be associated with the set of common attributes of the subset of user profiles. Being associated with the set of common attributes, each data set may be stored with data or metadata containing or indicating an attribute with which the data set is associated. In some embodiments, the data set and corresponding indication of associated attribute may be stored in a database, such as database 16 or database 18. The attribute component 220 may identify the plurality of data sets as a set of available instructional courses available to members of the social networking system 10.

In some embodiments, the attribute component 220 determines one or more data sets, of the plurality of data sets, is associated with the one or more common attributes introduced within the specified time period. The attribute component 220 may parse the plurality of data sets for an indication of the one or more common attribute. In instances where the data sets are stored with data or metadata indicating an associated common attribute, the attribute component 220 may parse the data or metadata for the associated common attributes and match one or more of the attributes from the data or metadata with the one or more common attributes of the specified time period. In response to matching the one or more attributes, the attribute component 220 determines data sets associated with the one or more matched attributes as the one or more data sets to be displayed in operation 370.

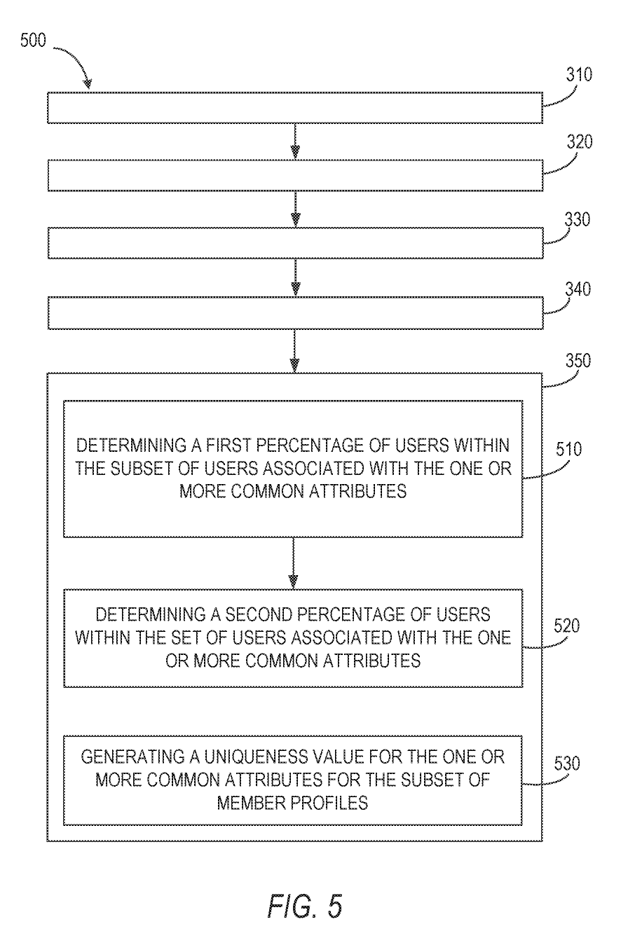

FIG. 5 is a flow diagram illustrating a method 500 of identifying attributes among sets of user profiles to identify data sets (e.g., instructional content) configured to support incorporation of a selected attribute into a user profile, consistent with various embodiments described herein. The method 500 may be performed, at least in part, by, for example, the content server system 22 illustrated in FIG. 2 (or an apparatus having similar components, such as one or more client devices 8 or application servers). In some embodiments, the method 500 includes one or more operations from the method 300. As shown in FIG. 5, the method 500 may be performed as one or more sub-operations of method 300 in operation 350.

In operation 510, the attribute component 220 determines a first percentage of users within the subset of users associated with the one or more common attributes. In some embodiments, the first percentage represents a percentage of users in a group defined by the common characteristic who are associated with the one or more common attributes. For example, where the one or more common attributes is programming in Language A, the attribute component 220 may determine that 10% of members have Language A included in a member profile and belong to one or more of the subset of members or the group of members defined by the common characteristic. In this example the common characteristic may be a common job, such as “software developer.”

In operation 520, the attribute component 220 determines a second percentage of users within the set of users associated with the one or more common attributes. The attribute component 220 may determine the second percentage similarly to the first percentage. In such embodiments, the attribute component 220 may determine the second percentage as a percentage of members having Language A included in a member profile and belonging to the social networking system 10. For example, the attribute component 220 may determine that 0.1% of the set of members (e.g., a global set of members of the social networking system 10) are associated with profiles listing Language A.

In operation 530, the value component 260 generates a uniqueness value for the one or more common attributes for the subset of user profiles. In some embodiments, the value component 260 generates the uniqueness value of the attribute for the subset of member profiles by determining a difference between the first percentage and the second percentage. For example, in some instances, the value component 260 may generate the uniqueness value by dividing or multiplying the first percentage by the second percentage. In some embodiments, the value component 260 generates the uniqueness value based on a combination of percentages generated for the subset of members (e.g., the group of users defined by the common characteristic), the set of members of the social networking system 10, and one or more other subsets of members attributed to one or more other groups defined by other common characteristics. For example, one or more of the attribute component 220 and the value component 260 may calculate percentages for the set of members and the subset of members associated with the common characteristic and the one or more common attributes, to generate the second percentage and the first percentage, respectively. The attribute component 220 or the value component 260 may then calculate one or more subsequent percentages for one or more groups of members unassociated with the common characteristic, but associated with characteristics related to the common characteristic. The value component 260 may incorporate the subsequent percentages into the uniqueness value to generate a representation of the common attribute to a group of members which distinguishes the group of members from subsequent but related groups of members.

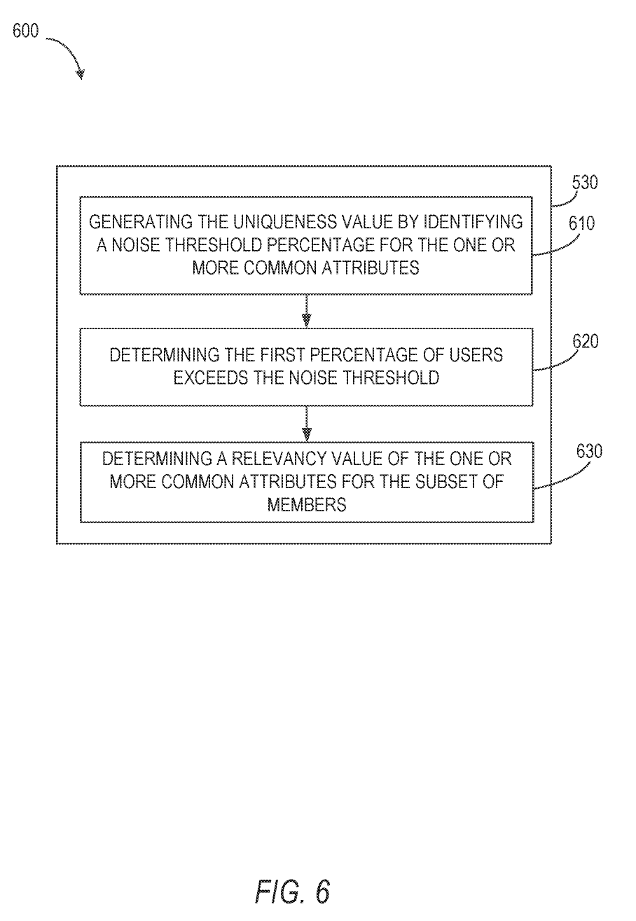

FIG. 6 is a flow diagram illustrating an example method 600 of identifying attributes among sets of user profiles to identify data sets (e.g., instructional content) configured to support incorporation of a selected attribute into a user profile, consistent with various embodiments described herein. The method 600 may be performed, at least in part, by, for example, the content server system 22 illustrated in FIG. 2 (or an apparatus having similar components, such as one or more client devices 8 or application servers). In some embodiments, the method 600 is performed as a sub-operation or other part of the methods 300 or 500. As shown in FIG. 6, the method 600 is performed as one or more sub-operations of method 500 in operation 530.

In operation 610, the value component 260 generates the uniqueness value by identifying a noise threshold percentage for the one or more common attributes. The noise threshold may be a predetermined percentage. In some instances, the noise threshold is a percentage determined dynamically. The dynamic noise threshold may be determined in response to one or more percentages calculated for common attributes calculated for a group of members. The noise threshold may be a percentage below which an attribute is determined to be noise within a group or subset of users. In some embodiments, the noise threshold is set at a value between 1% and 10%, representing between 1% and 10% of the members of the group of members being associated with the one or more common attribute. Where the noise threshold is predetermined, the value component 260 may identify the noise threshold by accessing the noise threshold stored in a database associated with or accessible by the content server system 22. In such instances, differing noise thresholds may be predetermined and stored for or with differing groups of members, characteristics defining groups of members, attributes associated with one or more of the groups of members or characteristics, or any other suitable portion of data contained within the database.

In operation 620, the value component 260 determines that the first percentage of users exceeds the noise threshold. The value component 260 may determine the first percentage of members exceeds the noise threshold by comparing a value of the first percentage with a value of the noise threshold. Where the value of the first percentage is greater than the value of the noise threshold, the value component 260 determines that the first percentage exceeds the noise threshold.

In some instances, the value component 260 may determine that the first percentage exceeds the noise threshold using a weighted comparison. The weighted comparison may increase or decrease a value of the first percentage based on one or more context of the one or more common attribute, the group of members, or the common characteristic defining the group of members. For example, where a number of members in the group of members is below a group threshold, the value component 260 may apply a weight to the first percentage to decrease a value of the first percentage with respect to the noise threshold. Where the one or more attribute is common among one group and uncommon among another group for which that attribute is currently the common attribute, the value component 260 may apply a weight decreasing the value of the first percentage for the group of members. Further, where the one or more attribute is uncommon among the set of members but more common among the subset of members, the value component 260 may increase the value of the first percentage for comparison with the noise threshold.

In operation 630, the value component 260 determines a relevancy value of the one or more common attributes for the subset of users. In some embodiments, the relevancy value of the one or more common attributes comprises a relative relevancy value indicating a relative relevance of the one or more common attributes with respect to a set of attributes among user profiles for the subset of user profiles. In some instances, the relative relevance is determined for an industry, geographic area, the common characteristic defining the group of members, or any other suitable organization associated with the subset of members.

In some embodiments, in response to determining the relevancy value, the presentation component 250 generates a graphical representation of the set of common attributes for the user profiles of the subset of users, as shown in FIG. 4. In such embodiments, the presentation component 250 may generate the graphical representation as part of operation 360. The graphical representation, in these instances, may be based at least in part on the cluster representation. In response to generating the graphical representation, the presentation component 250 organizes the graphical representation according to one or more of the uniqueness value and the relevancy value.

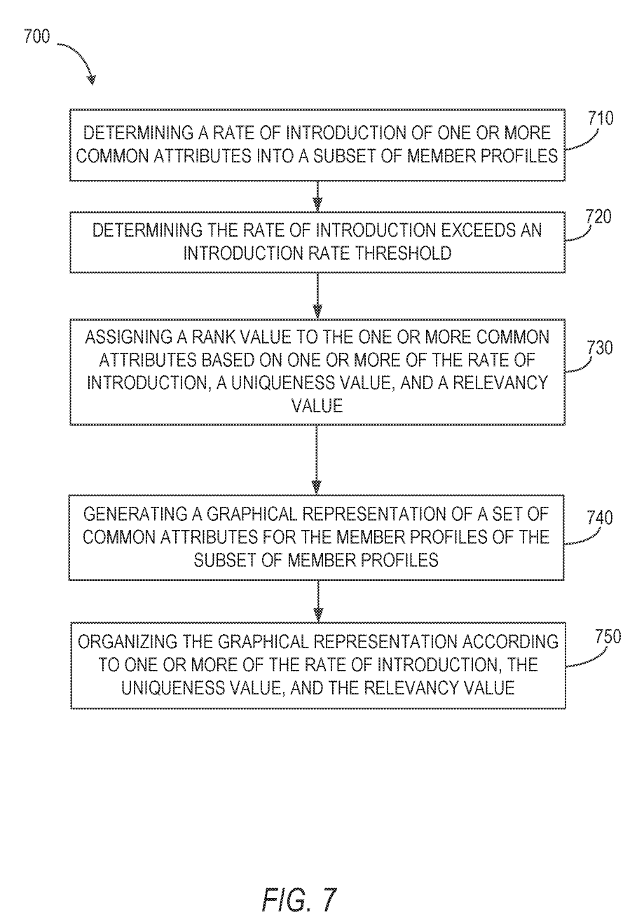

FIG. 7 is a flow diagram illustrating an example method 700 of identifying attributes among sets of user profiles to identify data sets (e.g., instructional content) configured to support incorporation of a selected attribute into a user profile, consistent with various embodiments described herein. The method 700 may be performed, at least in part, by, for example, the content server system 22 illustrated in FIG. 2 (or an apparatus having similar components, such as one or more client devices 8 or application servers). In some embodiments, the method 700 is performed as a sub-operation or other part of the methods 300, 500, or 600. For example, the method 700 may be performed as one or more sub-operations of method 300 in operation 350. Further, in some instances, the method 700 may be performed in operation 350 after performance of one or more operations of the method 600.

In operation 710, the attribute component 220 determines a rate of introduction of the one or more common attributes into the subset of user profiles. The attribute component 220 may determine the rate of introduction as a number of members introducing the one or more common attributes into an associated member profile within a given period of time. In some embodiments, the attribute component 220 selects or identifies a set of time increments extending backward from a current time. The attribute component 220 may determine a series of rates of introduction, by determining a rate of introduction for each time increment prior to the current time. In some embodiments, in determining the rate of introduction, the attribute component 220 selects a rate of introduction from the series of rates of introduction for use in the method 700, described below.

In operation 720, the attribute component 220 determines that the rate of introduction of the one or more common attributes exceeds an introduction rate threshold. In some embodiments, the attribute component 220 compares the rate of introduction, a selected rate of introduction, or a highest rate of introduction of the series of rates of introduction to the introduction rate threshold. The introduction rate threshold may be a value representing a number of introductions per increment of time. In such instances, a value exceeding the introduction rate threshold represents a trend for members of the group introducing the one or more common attributes to their profiles.

In operation 730, the attribute component 220 assigns a rank value to the one or more common attributes based on one or more of the rate of introduction, the uniqueness value, and the relevancy value. The rank value may be a single value, indicating a rank or status of the one or more common attributes, or may be a dynamic value, indicating a position of the one or more common attributes among the set of common attributes. For example, where the rank value is a single value, assignment of the rank value to the one or more common attributes may position the graphical representation (e.g., the bar) corresponding to the one or more common attributes above a specified position in the graphical user interface shown in FIG. 4. By way of further example, where the rank value is a dynamic value, assignment of a rank value to the one or more common attributes may determine the position of the one or more common attributes within the graphical user interface shown in FIG. 4.

In some embodiments where the rank value is the single value, the attribute component 220 assigns the rank value in response to the rate of introduction for the one or more common attributes exceeding the introduction rate threshold. In such embodiments, the rank value may position a graphical representation of the one or more common attributes above representations of common attributes which failed to exceed the introduction rate threshold. In some instances where the rank value is a dynamic value, the attribute component 220 orders the one or more common attributes according to the rank values assigned to each of the one or more common attributes and above the attributes of the set of common attributes unassociated with the rank value.

In operation 740, the presentation component 250 generates a graphical representation of the set of common attributes for the member profiles of the subset of users. In some embodiments, the graphical representation is based at least in part on the cluster representation. The graphical representation may be based on the cluster representation by presenting graphical representations for all of the common attributes of the set of common attributes in a single graphical user interface. In some instances, operation 740 is performed as a part of operation 360 of the method 300. The presentation component 250 may generate the graphical representation of the set of common attributes organized according to a first organization scheme. For example, the presentation component 250 may initially generate the graphical representation according to a number of members associated with each attribute.

In operation 750, the presentation component 250 organizes the graphical representation according to one or more of the rate of introduction, the uniqueness value, and the relevancy value. In some instances, operation 750 is performed as a part of operation 360 of the method 300. In some embodiments where the one or more common attributes are assigned rank values based on the rate of introduction of the one or more common attributes, the presentation component 250 may organize and cause presentation of the graphical representation in a manner described above, with respect to operation 730. In embodiments where the presentation component 250 organizes the graphical representation according to the uniqueness value or the relevancy value, the presentation component 250 may order the common attributes of the set of common attributes and including the one or more common attributes according to a uniqueness value or relevancy value generated for each common attribute. In some instances, the presentation component 250 organizes the graphical representation according to a plurality of the rate of introduction (e.g., the rank value), the uniqueness value, and the relevancy value. In such instances, the presentation component 250 may use two or more of the rank value, the uniqueness value, and the relevancy value as input to an organization algorithm. For example, the presentation component 250 may organize the common attributes based on a combined (e.g., added) value of two or more of the rank value, the uniqueness value, and the relevancy value.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented components or objects that operate to perform one or more operations or functions. The components and objects referred to herein may, in some example embodiments, comprise processor-implemented components and/or objects.

Similarly, the methods described herein may be at least partially processor-implemented. For example, at least some of the operations of a method may be performed by one or more processors or processor-implemented components. The performance of certain operations may be distributed among the one or more processors, not only residing within a single machine or computer, but deployed across a number of machines or computers. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., APIs).

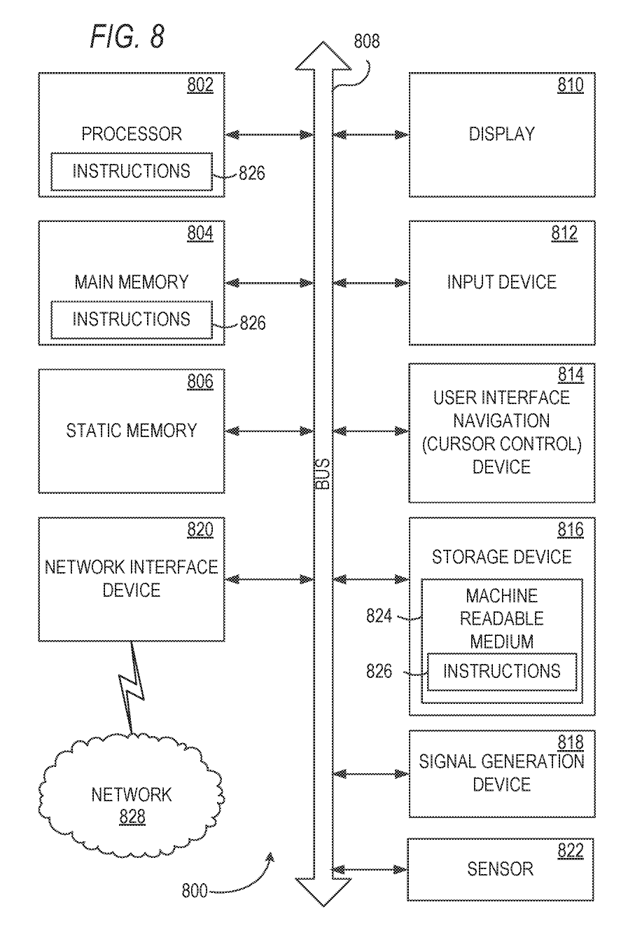

FIG. 8 is a block diagram of a machine in the form of a computer system 800 within which a set of instructions may be executed for causing the machine to perform any one or more of the methodologies discussed herein. For example, the computer system 800 may be a server functioning as the content server system 22. In some instances, the computer system 800 may be a set of similar computing devices storing instructions capable of configuring a processor of the computer system 800 as one or more of the components (hardware-software implemented components) described above. The configuration of a component, even for a period of time, causes the computer system 800 to act as a special-purpose computing device for performing one or more operations associated with the component, as described in the present disclosure. In some embodiments, the computer system 800 may function as the social networking system 10 with portions (e.g., hardware and instructions) partitioned to function as one or more of the components, interfaces, or systems described above during specified operations associated with those aspects of the components, interfaces, and systems.

In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a various embodiments, the machine may be a server computer; however, in alternative embodiments, the machine may be a personal computer (PC), a tablet PC, a set-top box (STB), a personal digital assistant (PDA), a mobile telephone, a web appliance, a network router, a network switch, a network bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 800 includes a processor 802 (e.g., a central processing unit (CPU), a graphics processing unit (GPU), a hardware processor, hardware processors, or any combination thereof), a main memory 804, and a static memory 806, which communicate with each other via a bus 808. The computer system 800 may further include a display unit 810, an alphanumeric input device 812 (e.g., a keyboard), and a user interface navigation device 814 (e.g., a mouse). In one embodiment, the display unit 810, alphanumeric input device 812, and UI navigation device 814 are a touch screen display. The computer system 800 may additionally include a storage device 816 (e.g., drive unit), a signal generation device 818 (e.g., a speaker), a network interface device 820, and one or more sensors 822, such as a global positioning system sensor, compass, accelerometer, or other sensor.

The storage device 816 includes a machine-readable medium 824 (e.g., non-transitory processor-readable storage medium) on which is stored one or more sets of instructions 826 (e.g., processor executable instructions) and data structures embodying or utilized by any one or more of the methodologies or functions described herein. The instructions 826 (e.g., processor-executable instructions) may also reside, completely or at least partially, within the main memory 804 (e.g., non-transitory machine-readable storage medium) and/or within the processor 802 during execution thereof by the computer system 800, with the main memory 804 and the processor 802 also constituting machine-readable media 824.

While the machine-readable medium 824 is illustrated in an example embodiment to be a single medium, the term “machine-readable medium” may include a single medium or multiple media (e.g., a centralized or distributed database, and/or associated caches and servers) that store the one or more instructions 826. The term “machine-readable medium” shall also be taken to include any tangible medium that is capable of storing, encoding, or carrying the instructions 826 for execution by the machine and that cause the machine to perform any one or more of the methodologies of the present disclosure, or that is capable of storing, encoding, or carrying data structures utilized by or associated with such instructions 826. The term “machine-readable medium” shall accordingly be taken to include, but not be limited to, solid-state memories, and optical and magnetic media. Specific examples of machine-readable media 824 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disk read only memory (CD-ROM) and digital video disk read only memory (DVD-ROM) disks.

The instructions 826 may further be transmitted or received over a communication network 828 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi® and WiMax® networks). The term “transmission medium” shall be taken to include any intangible medium that is capable of storing, encoding, or carrying the instructions 826 for execution by the machine, and includes digital or analog communications signals or other intangible media to facilitate communication of such software.

Although embodiments have been described with reference to specific examples, it will be evident that various modifications and changes may be made to these embodiments without departing from the broader scope of the inventive concepts of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
receiving a set of identifiers for a set of users, the set of identifiers associated with a set of user profiles comprising attributes of the set of users;
identifying, by one or more hardware processors, a set of common attributes among a subset of the set of users, the set of common attributes associated with a subset of user profiles of the subset of users;
determining that the subset of user profiles contain a common characteristic associated with the subset of users, the common characteristic defining a group of users including the subset of users;
generating a cluster representation comprising the set of common attributes for user profiles of the subset of users in the group of users;
determining that one or more common attributes of the set of common attributes are introduced into the subset of user profiles within a specified period of time;
in response to determining the one or more common attributes, causing presentation of the one or more common attributes within a graphical user interface presented at a client device associated with a first user, the one or more common attributes being identified in a presentation comprising the cluster representation of the set of common attributes, the first user being associated with a first user profile containing the common characteristic; and
in response to causing presentation of the one or more common attributes, causing presentation of one or more data sets associated with the one or more common attributes within a graphical user interface presented at the client device associated with the first user.

2. The method of claim 1, wherein identifying the set of common attributes further comprises:
parsing attributes comprising the set of user profiles;
matching a plurality of attributes among the set of user profiles; and
identifying a set of mismatching attributes among the set of user profiles.

3. The method of claim 2, wherein determining the subset of user profiles containing the common characteristic further comprises:
identifying one or more attributes of the set of mismatching attributes within the subset of user profiles, the one or more attributes being common to the subset of user profiles; and
selecting the one or more attributes as the one or more common attributes for the subset of user profiles.

4. The method of claim 1 further comprising:
determining a first percentage of users within the subset of users associated with the one or more common attributes,
determining a second percentage of users within the set of users associated with the one or more common attributes; and
generating a uniqueness value for the one or more common attributes for the subset of user profiles.

5. The method of claim 4, wherein generating the uniqueness value further comprises:
identifying a noise threshold percentage for the one or more common attributes;
determining the first percentage of users exceeds the noise threshold percentage; and
determining a relevancy value of the one or more common attributes for the subset of users.

6. The method of claim 5, wherein determining the relevancy value of the one or more common attributes comprises a relative relevancy value indicating a relative relevance of the one or more common attributes with respect to a set of attributes among user profiles for the subset of user profiles.

7. The method of claim 5, wherein causing presentation of the one or more common attributes within the graphical user interface further comprises:
generating a graphical representation of the set of common attributes for the user profiles of the subset of users, wherein the graphical representation is based at least in part on the cluster representation; and
organizing the graphical representation according to one or more of the uniqueness value and the relevancy value.

8. The method of claim 5, wherein determining one or more common attributes of the set of common attributes are introduced within the specified period of time further comprises:
determining a rate of introduction of the one or more common attributes into the subset of user profiles;
determining the rate of introduction of the one or more common attributes exceeds an introduction rate threshold; and
assigning a rank value to the one or more common attributes based on one or more of the rate of introduction, the uniqueness value, and the relevancy value.

9. The method of claim 8, wherein causing presentation of the one or more common attributes within the graphical user interface further comprises:
generating a graphical representation of the set of common attributes for the user profiles of the subset of users, wherein the graphical representation is based at least in part on the cluster representation; and
organizing the graphical representation according to one or more of the rate of introduction, the uniqueness value, and the relevancy value.

10. A system, comprising:
one or more processors; and
a non-transitory processor-readable storage medium coupled to the one or more processors, the non-transitory processor-readable storage medium storing processor-executable instructions that, when executed by the one or more processors, cause the one or more processors to perform operations comprising:
receiving a set of identifiers for a set of users, the set of identifiers associated with a set of user profiles comprising attributes of the set of users;
identifying a set of common attributes among a subset of the set of users, the set of common attributes associated with a subset of user profiles of a subset of the set of users;
determining that the subset of user profiles contain a common characteristic associated with the subset of users, the common characteristic defining a group of users including the subset of users;
generating a cluster representation comprising the set of common attributes for user profiles of the subset of users in the group of users;
determining that one or more common attributes of the set of common attributes are introduced into the subset of user profiles within a specified period of time;
in response to determining the one or more common attributes, causing presentation of the one or more common attributes within a graphical user interface presented at a client device associated with a first user, the one or more common attributes being identified in a presentation comprising the cluster representation of the set of common attributes, the first user being associated with a first user profile containing the common characteristic; and
in response to causing presentation of the one or more common attributes, causing presentation of one or more data sets associated with the one or more common attributes within a graphical user interface presented at the client device associated with the first user.

11. The system of claim 10, wherein identifying the set of common attributes further comprises:
parsing attributes comprising the set of user profiles;
matching a plurality of attributes among the set of user profiles;
identifying a set of mismatching attributes among the set of user profiles;
identifying one or more attributes of the set of mismatching attributes within the subset of user profiles, the one or more attributes being common to the subset of user profiles; and
selecting the one or more attributes as the one or more common attributes for the subset of user profiles.

12. The system of claim 10, wherein the operations further comprise:
determining a first percentage of users within the subset of users associated with the one or more common attributes;
determining a second percentage of users within the set of users associated with the one or more common attributes; and
generating a uniqueness value for the one or more common attributes for the subset of user profiles.

13. The system of claim 12, wherein generating the uniqueness value further comprises:
identifying a noise threshold percentage for the one or more common attributes;
determining the first percentage of users exceeds the noise threshold percentage; and
determining a relevancy value of the one or more common attributes for the subset of users.

14. The system of claim 13, wherein causing presentation of the one or more common attributes within the graphical user interface further comprises:
generating a graphical representation of the set of common attributes for the user profiles of the subset of users, wherein the graphical representation is based at least in part on the cluster representation; and
organizing the graphical representation according to one or more of the uniqueness value and the relevancy value.

15. The system of claim 13, wherein determining one or more common attributes of the set of common attributes are introduced within the specified period of time further comprises:
determining a rate of introduction of the one or more common attributes into the subset of user profiles;
determining the rate of introduction of the one or more common attributes exceeds an introduction rate threshold; and
assigning a rank value to the one or more common attributes based on one or more of the rate of introduction, the uniqueness value, and the relevancy value.

16. The system of claim 15, wherein causing presentation of the one or more common attributes within the graphical user interface further comprises:
generating a graphical representation of the set of common attributes for the user profiles of the subset of users, wherein the graphical representation is based at least in part on the cluster representation; and
organizing the graphical representation according to one or more of the rate of introduction, the uniqueness value, and the relevancy value.

17. A non-transitory processor-readable storage medium storing processor executable instructions that, when executed by a processor of a machine, cause the machine to perform operations comprising:
receiving a set of identifiers for a set of users, the set of identifiers associated with a set of user profiles comprising attributes of the set of users;
identifying a set of common attributes among a subset of the set of users, the set of common attributes associated with a subset of user profiles of the subset of users;
determining that the subset of user profiles contain a common characteristic associated with the subset of users, the common characteristic defining a group of users including the subset of users;
generating a cluster representation comprising the set of common attributes for user profiles of the subset of users in the group of users;
determining that one or more common attributes of the set of common attributes are introduced into the subset of user profiles within a specified period of time;
in response to determining the one or more common attributes, causing presentation of the one or more common attributes within a graphical user interface presented at a client device associated with a first user, the one or more common attributes being identified in a presentation comprising the cluster representation of the set of common attributes, the first user being associated with a first user profile containing the common characteristic; and
in response to causing presentation of the one or more common attributes, causing presentation of one or more data sets associated with the one or more common attributes within a graphical user interface presented at the client device associated with the first user.

18. The non-transitory processor-readable storage medium of claim 17, wherein identifying the set of common attributes further comprises:
parsing attributes comprising the set of user profiles;
matching a plurality of attributes among the set of user profiles;
identifying a set of mismatching attributes among the set of user profiles;
identifying one or more attributes of the set of mismatching attributes within the subset of user profiles, the one or more attributes being common to the subset of user profiles; and
selecting the one or more attributes as the one or more common attributes for the subset of user profiles.

19. The non-transitory processor-readable storage medium of claim 17, wherein the operations further comprise:
determining a first percentage of users within the subset of users associated with the one or more common attributes,
determining a second percentage of users within the set of users associated with the one or more common attributes; and
generating a uniqueness value for the one or more common attributes for the subset of user profiles.

20. The non-transitory processor-readable storage medium of claim 19, wherein generating the uniqueness value further comprises:
identifying a noise threshold percentage for the one or more common attributes;
determining that the first percentage of users exceeds the noise threshold percentage; and
determining a relevancy value of the one or more common attributes for the subset of users.
